(19) United States
(12) Patent Application Publication
(10) Pub. No.: US 2014/0064325 A1
(43) Pub. Date: Mar. 6, 2014

(54) WHEELSPACE FLOW VISUALIZATION USING PRESSURE-SENSITIVE PAINT

(71) Applicant: Kevin Richard KIRTLEY, Simpsonville, SC (US)

(72) Inventor: Kevin Richard KIRTLEY, Simpsonville, SC (US)

(73) Assignee: General Electric Company, Schenectady, NY (US)

(21) Appl. No.: 13/605,659

(22) Filed: Sep. 6, 2012

(51) Int. Cl. G01K 3/00

(52) U.S. Cl. 374/112; 374/E03.001

(57) ABSTRACT

A method of measuring local temperature variations at an interface between hot combustion gases in a turbine hot gas path and cooler purge air in a turbine rotor wheelspace includes applying a pressure- or temperature-sensitive paint to a rotatable turbine component where the hot combustion gas interacts with the purge air; locating at least one illumination device and at least one image-detecting device on a stationary component located proximate to the pressure sensitive paint; and, during operation of the turbine, imaging color changes in the pressure sensitive paint caused by local variations in partial pressure of oxygen which changes with temperature.

### BACKGROUND OF THE INVENTION

This invention relates to gas turbine engine technology generally, and to the investigation of fluid dynamics inside wheel spaces and rotor cavities of the gas turbine engine.

In gas turbine engines, attempts have been made to achieve a multi-dimensional understanding of the fluid dynamics inside turbine wheelspaces and rotor cavities, but have not been successful due in part to the traditional optical-access challenges with laser diagnostic methods like PIV, and surface flow visualization like oil flow.

Pressure sensitive paints have been used as a diagnostic tool in wind tunnel tests (see U.S. Pat. Nos. 7,290,444 and 5,186,046); to determine heat transfer characteristics of a three-dimensional airfoil model (see U.S. Pat. No. 8,104,953), etc. Pressure sensitive paint system controls including illumination and detection devices are shown in U.S. Pat. No. 6,474,173 and U.S. Pat. No. 5,612,492.

There remains a need for an arrangement that permits three-dimensional flow analysis in confined, hard-to-access regions of a turbine engine, such as the rotor wheelspace cavities and the narrow region where the rotor cavities interface with the hot combustion gas flowpath.

### BRIEF SUMMARY OF THE INVENTION

In accordance with an exemplary but nonlimiting embodiment, a method of measuring local temperature variations at an interface between hot combustion gases in a turbine hot gas path and cooler purge air in a turbine rotor wheelspace comprising applying pressure or temperature sensitive paint to a rotatable turbine component where the hot combustion gas interacts with the purge air; locating at least one illumination device and at least one image-detecting device on a stationary component located proximate to the pressure sensitive paint; and during operation of the turbine, imaging color changes in the pressure sensitive paint caused by local variations in partial pressure of oxygen which changes with temperature.

In another aspect, a method for measuring temperature variations in a tortuous radial-oriented path between a hot gas flow path of combustion gases and a purge air flow path within a turbine rotor wheelspace, the radially-oriented path having upstream and downstream sides relative to the flow of combustion gases along the hot gas flow path, the method comprising applying pressure or temperature-sensitive paint to a rotating component on the downstream side of the radially-oriented path; locating at least one illumination device and at least one image detecting device on a stationary component on the upstream side of the radially-oriented path; during operation of the gas turbine, imaging color changes in the pressure or temperature-sensitive paint; and developing a temperature-based flow representation within the radially-oriented gap.

The invention will now be described in greater detail in conjunction with the drawings identified below.

### BRIEF DESCRIPTION OF THE DRAWINGS

FIG. 1 is a simplified partial side elevation of a turbine rotor wheelspace and hot gas path in a gas turbine;

FIG. 2 is a schematic side elevation of a turbine rotor and turbine nozzle, illustrating the convergence of wheelspace purge air and hot combustion gases at the turbine rotor angel wing seals; and

FIG. 3 is a schematic partial front elevation of the arrangement shown in FIG. 2.

### DETAILED DESCRIPTION OF THE INVENTION

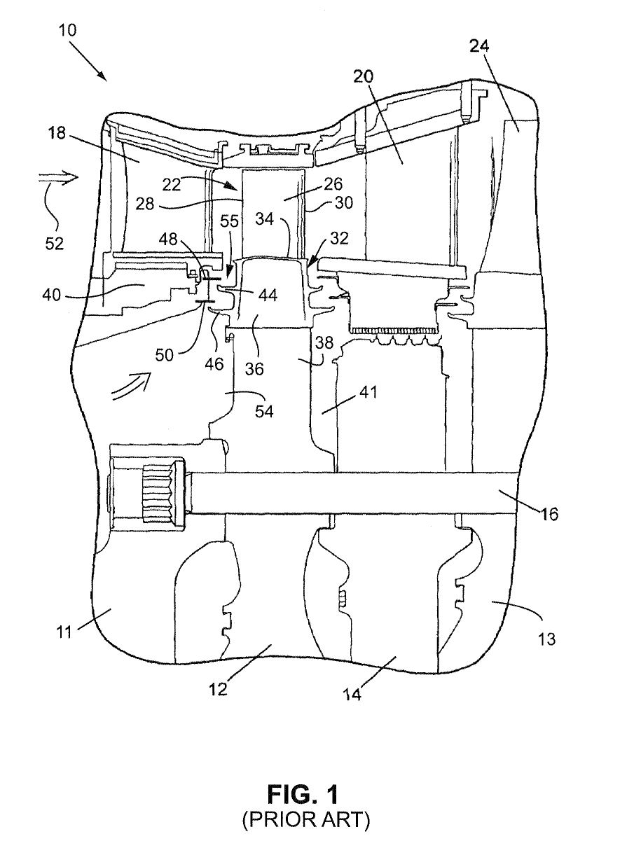

FIG. 1 illustrates a section of a typical stationary nozzle and rotating bucket in one stage of a gas turbine, generally designated 10. A rotor 11 is provided with axially spaced rotor wheels 12, 13 and spacers 14 joined one to the other by a plurality of circumferentially spaced, axially-extending bolts 16. In the illustrated example, first-stage nozzle 18 and second-stage nozzle 20 each include a plurality of circumferentially-spaced, stationary stator blades in surrounding relationship to the rotor. Between the nozzles, and rotating with the rotor and rotor wheels 12, 13 are first and second-stage rotor blades or buckets 22 and 24, respectively, mounted on the wheels in conventional fashion.

Each bucket (for example, bucket 22 of FIG. 1) includes an airfoil 26 having a leading edge 28 and a trailing edge 30, supported radially outwardly of a shank 32 including a platform 34 and a shank pocket 36 having integral cover plates. A dovetail portion 38 of the bucket (radially inward of the shank but not shown in detail) is adapted for connection with generally corresponding dovetail slot formed in the rotor wheel 12. Bucket 22 is typically integrally cast and includes axially-projecting inner and outer angel wing seals 44, 46, respectively, that cooperate with seal lands 48, 50 formed on the adjacent nozzle diaphragm 40 to limit ingestion of hot combustion gases flowing through the hot gas path, generally indicated by the arrow 52, into wheelspace cavities located radially between the buckets and the rotor, indicated at 54. By at least partially interdigitating the angel wing seals 44, 46 and nozzle lands 48, 50 a tortuous or serpentine radial gap 55 is established that inhibits hot combustion gas ingress into the wheelspace. Thus, the gap 55 is formed by an upstream surface of the wheel or bucket and an adjacent downstream surface of the nozzle diaphragm. It is to be understood that ingestion of hot combustion gases is also inhibited by cooler purge air flowing through the wheelspace, some of which seeks to exit via the path 55. Understanding the flow dynamics at his interface is of great interest and is the area of interest with respect to this disclosure.

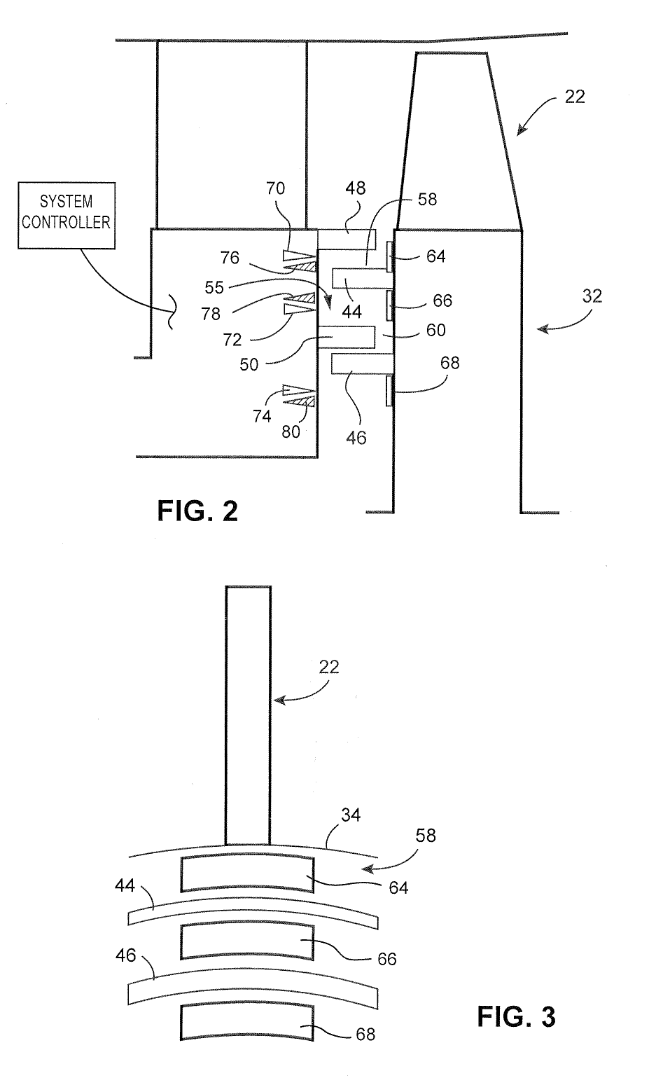

With reference to both FIGS. 1 and 2, the area between the edge of the bucket platform 34 and the outer angel wing seal 46 forms a so-called “trench cavity” 58 where cooler purge air escaping from the wheel space directly interfaces with the hot combustion gases. The area between the inner and outer angel wing seals 44, 46 forms a so-called “buffer” area or zone 60 between the different temperature regions. Generally, by maintaining cooler temperatures within the trench cavity 58, service life of the angel wing seals 44, 46, and hence the bucket itself, can be extended.

FIGS. 2 and 3 illustrate an exemplary but nonlimiting arrangement that illustrates one scheme for the application of PSP to effectively gather information relating to local temperature variations within the entire radial gap 55. Specifically, PSP is applied to the rotor wheel and/or bucket shank portions in radially aligned areas between the bucket platform 34 and the outer angel wing seal 44; between the inner and outer angel wing seals 46, 44, respectively; and radially inward of the inner angel wing seal 46. The PSP may be applied in arcuate or rectangular patches or patterns or patches indicated at 64, 66 and 68. Note that the PSP patterns 62 and 64 lie directly within the serpentine path formed by the angel wing seals and opposed lands 48, 50.

Opposite the respective PSP patterns 64, 66, 68 there are located radiation-source or illumination devices 70, 72, 74 (which may be LEDs with a low power white-light output, with no filtering). Adjacent each illumination device is a detection device such as an automatic, continuous high-speed camera 76, 78, 80 with good resolution. Both the illumination devices and detection device may be chosen from those currently available that are advantageously for use with PSP. The confined space and access issues attendant gas turbine applications, and especially the hard-to-reach areas of concern here, will dictate the specific illumination and detection devices used.

The PSP changes color based on local variations in the partial pressure of oxygen which varies with temperature. Accordingly, recording the images and sending them to a system controller/data analysis unit where they are manipulated through known digital enhancement techniques such as phase-locking, produces in this case a surface flow representation at the interface of the wheelspace purge air and the hot combustion gases. In this regard, the hot combustion gases at the first turbine stage may be on the order of 400° F., while the purge air may be up to 200° F. The data can thus be transformed into a temperature profile and/or temperature-based flow representation that can identify whether and to what extent hot combustion gases are being ingested into the wheelspace cavities, and where the mixing of the two is occurring at that interface. In other words, one skilled in the art can interrogate the obtained images and deduce the convective flow patterns inside the wheelspace and assess performance of the angel wing seals and/or heat transfer on the hard, rotating surfaces of the seal and/or adjacent surfaces of the wheel.

To further enhance the visualization results, it is possible to seed the wheelspace purge air with a gas such as CO2 that is devoid of oxygen, and therefore enhance the color differentiation of the PSP. In other words, the partial pressure of oxygen will vary not only with temperature but also with seed gas concentration. Other relatively inert gases could also be used as a seed gas for the purge air. In any event, when the purge flow is laced with a seed gas, any measurement error can be reduced by reducing the temperature difference between the purge flow and the ingested core (hot combustion gas) flow.

While PSP has been identified as a suitable measurement vehicle, it will be understood that temperature-sensitive paint (TSP) may be used to achieve the same goals. Often regarded or referred to as “liquid crystals” the time constant of TSPs is longer so the obtained measurement is more of an “average”.

The paint, whether a PSP or a TSP, may be applied as shown in arcuate or rectangular segments (FIG. 3) on one or more buckets and adjacent wheel surfaces spaced circumferentially about the rotor, or it may also be applied in continuous, annular rings. Further, while at least one set of illumination and detection devices is illustrated, two or more sets may be employed at circumferentially-spaced locations to detect circumferential anomalies within the temperature distribution both radially and about the circumference of the wheel.

It is also noted that the above diagnostic process has been described in conjunction with an upstream side of a turbine bucket. A similar arrangement may be applied in the radial gap at the downstream side of the bucket, as well as in other hard-to-reach areas where temperature differentials and flow dynamics are of concern.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of measuring local temperature variations at an interface between hot combustion gases in a turbine hot gas path and cooler purge air in a turbine rotor wheelspace comprising:
a. applying pressure- or temperature-sensitive paint to a rotatable turbine component where the hot combustion gas interacts with the purge air;
b. locating at least one illumination device and at least one image-detecting device on a stationary component located proximate to the pressure sensitive paint; and
c. during operation of the turbine, imaging color changes in the pressure- or temperature-sensitive paint caused by local variations in partial pressure of oxygen.

2. The method of claim 1 wherein said rotatable turbine component comprises a turbine rotor mounting a plurality of buckets.

3. The method of claim 2 wherein said pressure- or temperature-sensitive paint is applied above, between and below a pair of seals axially extending from an upstream side of at least one of plurality of said buckets.

4. The method of claim 1 wherein said illumination device comprises an LED.

5. The method of claim 4 wherein said image detecting device comprises a high-speed camera.

6. The method of claim 3 wherein said pressure- or temperature-sensitive paint is applied in radially-spaced patches at least one of said plurality of buckets, circumferentially-spaced about the rotor.

7. The method of claim 3 wherein said pressure- or temperature-sensitive paint is applied in substantially continuous ring form to said rotor and said plurality of buckets.

8. The method of claim 3 wherein seal lands extend axially from said stationary component, at least partially interdigitated with said pair of seals, such that said interface comprises a tortuous flow path between said hot gas path and said wheelspace.

9. The method of claim 2 wherein a pair of radially-spaced angel wing seals project axially away from each of said plurality of buckets, and wherein said pressure- or temperature-sensitive paint is applied to said rotor and at least one of said plurality of buckets radially outward of a radially outer one of said angel wing seals; radially between said pair of radially-spaced angel wing seals; and radially inward of a radially-inner one of said angel wing seals.

10. A method for measuring temperature variations in a tortuous radial-oriented path between a hot gas flow path of combustion gases and a purge air flow path within a turbine rotor wheelspace, the radially-oriented path having upstream and downstream sides relative to the flow of combustion gases along the hot gas flow path, the method comprising:
a. applying pressure or temperature-sensitive paint to a rotating component on the downstream side of said radially-oriented path;
b. locating at least one illumination device and at least one image detecting device on a stationary component on the upstream side of said radially-oriented path;
c. during operation of the gas turbine, imaging color changes in the pressure or temperature-sensitive paint; and
d. developing a flow representation based on said paint within said radially-oriented gap.

11. The method of claim 10 wherein said rotating turbine component comprises a turbine rotor mounting a plurality of buckets.

12. The method of claim 11 wherein said pressure- or temperature-sensitive paint is applied above, between and below a pair of seals axially extending from an upstream side of at least one of said buckets.

13. The method of claim 10 wherein said at least one illumination device comprises an LED.

14. The method of claim 10 wherein said at least one image detecting device comprises a high-speed camera.

15. The method of claim 11 wherein said pressure- or temperature-sensitive paint is applied in radially and circumferentially-spaced patches at least two of said plurality of buckets spaced about the rotor.

16. The method of claim 11 wherein said pressure- or temperature-sensitive paint is applied in substantially continuous ring form on said rotor and said plurality of buckets.

17. The method of claim 12 wherein seal lands extend axially from said stationary component, at least partially interdigitated with said pair of seals.

18. The method of claim 11 wherein a pair of radially-spaced angel wing seals project axially away from each of said plurality of buckets, and wherein said pressure- or temperature-sensitive paint is applied to at least one of said plurality of buckets radially outward of a radially outer one of said angel wing seals; radially between said pair of radially-spaced angel wing seals, and radially inward of a radially-inner one of said angel wing seals.

19. The method of claim 10 wherein a seed gas is added to the purge air to enhance imaging of the color changes.

20. The method of claim 19 where in the seed gas is CO₂.
